(19) United States
(12) Patent Application Publication
(10) Pub. No.: US 2013/0076463 A1
(43) Pub. Date: Mar. 28, 2013

(54) ELECTROMAGNETIC CONTACTOR AND ASSEMBLY METHOD FOR THE SAME

(71) Applicants: Kouetsu Takaya, Kounosu-shi (JP); Koji Okubo, Kounosu-shi (JP); Yasuhiro Naka, Kounosu-shi (JP); Kenji Suzuki, Kounosu-shi (JP)

(72) Inventors: Kouetsu Takaya, Kounosu-shi (JP); Koji Okubo, Kounosu-shi (JP); Yasuhiro Naka, Kounosu-shi (JP); Kenji Suzuki, Kounosu-shi (JP)

(73) Assignee: FUJI ELECTRIC FA COMPONENTS & SYSTEMS CO.,LTD., Tokyo, (JP)

(21) Appl. No.: 13/519,759

(22) PCT Filed: Dec. 20, 2010
(86) PCT No.: PCT/JP2010/007384

§ 371 Date: Aug. 7, 2012

(30) Foreign Application Priority Data
May 27, 2010 (JP) 2010-121653

(51) Int. Cl. H01H 50/64; H01H 49/00

(52) U.S. Cl. CPC H01H 50/643; H01H 49/00
USPC 335/189; 29/622

(57) ABSTRACT

There is provided a drive lever incorrect assembly detection portion (9d) and (14) which causes another end portion (9a) of a drive lever (9) to protrude to a position, of a case (4), to which a cover (5) is attached such that the cover (5) cannot be attached to the case (4) in a state where the drive lever (9) is assembled in an incorrect direction.

### TECHNICAL FIELD

The present invention relates to an electromagnetic contactor having a drive lever which transmits an attraction movement and a release movement of a movable core of an electromagnet to a movable contact support, and an assembly method for the same.

### BACKGROUND ART

As an electromagnetic contactor, there is known a device of, e.g., Patent Document 1.

In the electromagnetic contactor of Patent Document 1, there are accommodated in a case, an electromagnet, a movable contact support disposed in parallel with the electromagnet, a return spring urging the movable contact support toward an initial position, and a drive lever which transmits an attraction movement and a release movement of the electromagnet to the movable contact support.

The movable contact support includes a plurality of movable contacts, moves against the return spring, and performs an opening and closing operation with fixed contacts disposed in the case so as to face the individual movable contacts. The electromagnet includes an exciting coil, a fixed core, and a movable core which is disposed to face the fixed core so as to be movable close to or away from the fixed core.

The drive lever is an elongated plate-like member, and is formed with arm portions in the central portion in a longitudinal direction, and a protrusion on one side surface of one end portion in a plate thickness direction.

One end portion of the drive lever is inserted into an insertion hole of the movable contact support, the arm portions thereof abut on a receiving surface formed on an opening peripheral edge of the insertion hole, and the drive lever is thereby engaged with the movable contact support. Further, the drive lever is assembled in a state where one end portion is inserted into a loose-fitting hole formed in the movable core, the protrusion formed at one end portion is contacting with an inner surface of the loose-fitting hole which is farthest from the fixed core, and the other end portion is engaged with a receiving groove formed in an inner wall of an upper case which faces the movable core via the movable contact support.

When the exciting coil of the electromagnet is brought into an excited state and the movable core of the electromagnet is attracted by the fixed core, the movement of the movable core by the attraction is transmitted to the drive lever via the protrusion at one end portion, and the drive lever rotates about the other end portion engaged with the receiving groove of the upper case, whereby the rotation of the drive lever is transmitted to the movable contact support as a predetermined stroke, the movable contact support moves from the initial position to an operation position, and the opening and closing operation of the individual movable contacts and the corresponding fixed contacts is performed.

Patent Document 1: Japanese Patent publication No. S64-48339 (FIGS. 1 and 2)

The drive lever of Patent Document 1 has directivity at the time of assembly that the drive lever is assembled in the state where the protrusion formed at one end portion is in contact with the inner surface of the loose-fitting hole formed in the movable core which is farthest from the fixed core.

However, even when the assembly of the drive lever of Patent Document 1 is performed in a state where the drive lever is oriented in the opposite direction in which the protrusion at one end portion does not abut on the inner surface of the loose-fitting hole (hereinafter referred to as incorrect assembly), the drive lever can be attached into an electromagnetic contactor, and therefore the incorrect assembly of the drive lever may impair the normal operation of the electromagnetic contactor.

That is, in the drive lever of Patent Document 1, there are formed a pair of arm portions which protrude outward in mutually opposite directions from end portions in a plate width direction at the same positions (the central portion) in the longitudinal direction and, even when the incorrect assembly of the drive lever is performed with the pair of arm portions disposed in a direction opposite to that in the correct assembly and caused to abut on the receiving surface of the insertion hole, the drive lever can be attached into the electromagnetic contactor.

In the drive lever assembled by the incorrect assembly, since the protrusion at one end portion does not contact with the inner surface of the loose-fitting hole formed in the movable core which is farthest from the fixed core, the movement operation of the movable core of the electromagnet may not be transmitted to the movable contact support as the predetermined stroke, and the opening and closing operation of the movable contacts and the fixed contacts may not be performed normally in the electromagnetic contactor having the drive lever assembled by the incorrect assembly.

### DISCLOSURE OF THE INVENTION

Consequently, in the electromagnetic contactor having the drive lever of Patent Document 1, it is necessary to visually ascertain the assembly direction of the drive lever at the time of the assembly, and there arises a problem that a time required for the assembly is increased and assembly efficiency is thereby reduced.

In view of the foregoing, the present invention has been achieved by focusing on the unsolved problem of the conventional art described above, and an object thereof is to provide an electromagnetic contactor and an assembly method for the same, capable of reliably preventing incorrect assembly of a drive lever having directivity at the time of assembly.

In order to achieve the foregoing object, an electromagnetic contactor according to an embodiment of the present invention is an electromagnetic contactor comprising a case accommodating an electromagnet having a movable core; a movable contact support moving in parallel with a moving direction of the movable core; and a drive lever which has directivity in.assembly in the case, one end portion engaged with the movable core, and a central portion in a longitudinal direction engaged with the movable contact support. The movement of the movable core is transmitted to the movable contact support by the drive lever made rotatable about another end portion of the drive lever serving as a rotation shaft by engaging the other end portion of the drive lever to an inner wall of a cover attached to the case covering the movable contact support. A drive lever incorrect assembly detection portion is provided in which in a state where the drive lever is assembled in a correct direction, the drive lever is accommodated to attach the cover to the case, and in a state where the drive lever is assembled in an incorrect direction, the other end portion of the drive lever protrudes to a position where the cover is to be attached to the case to prevent the attachment of the cover to the case.

According to the electromagnetic contactor according to the embodiment of the present invention, when the drive lever having directivity at the time of assembly is oriented in the incorrect direction and assembled in the case, since the attachment of the cover to the case is prevented by the drive lever incorrect assembly detection portion, it is possible to easily recognize the incorrect assembly of the drive lever.

In addition, in the electromagnetic contactor according to the embodiment of the present invention, the drive lever incorrect assembly detection portion comprises an arm portion formed in the central portion of the drive lever and protruding from one end portion in a direction orthogonal to a rotation direction of the drive lever, an arm portion receiving surface formed on the movable contact support, and on which the arm portion abuts while accommodating the drive lever to attach the cover to the case in the state in which the drive lever is assembled in the correct direction, and an incorrect assembly preventing surface formed on the movable contact support to be closer to a position where the cover is attached than the arm portion receiving surface, and on which the arm portion abuts to protrude the other end portion of the drive lever to the position where the cover is to be attached to the case in the state in which the drive lever is assembled in the incorrect direction.

According to the electromagnetic contactor according to the embodiment of the present invention, since the drive lever incorrect assembly detection portion is formed of the simple structure including the arm portion formed in the drive lever, and the arm portion receiving surface and the incorrect assembly preventing surface which are formed on the movable contact support into a stepped shape, a reduction in manufacturing cost is achieved.

Further, an assembly method for an electromagnetic contactor according to an embodiment of the present invention, comprising the steps of after accommodating the electromagnet, the movable contact support, and the drive lever in the case, judging whether attaching the cover to the case is possible, or whether the attaching the cover to the case is not possible by protruding the other end portion of the drive lever to the position where the cover is to be attached to the case, and determining the presence of the incorrect assembly of the drive lever.

According to the assembly method for an electromagnetic contactor according to the embodiment of the present invention, since it is possible to lessen work for visually ascertaining the orientation of the assembly of the drive lever when the drive lever is assembled, and reduce a time required for the assembly of the electromagnetic contactor, assembly efficiency is improved.

According to an electromagnetic contactor according to the present invention, when a drive lever having directivity at the time of assembly is oriented in an incorrect direction and assembled in a case, since the attachment of a cover to the case is prevented by a drive lever incorrect assembly detection portion, it is possible to easily recognize the incorrect assembly of the drive lever.

In addition, according to an assembly method for an electromagnetic contactor according to the present invention, since it is possible to lessen work for visually ascertaining an orientation of assembly of a drive lever when the drive lever is assembled, and reduce a time required for the assembly of the electromagnetic contactor, it is possible to improve assembly efficiency.

### BRIEF DESCRIPTION OF THE DRAWINGS

FIG. 1 is a perspective view showing an electromagnetic contactor of an embodiment according to the present invention;

FIG. 2 is an exploded perspective view showing constituent members of the electromagnetic contactor;

FIG. 3 is a cross-sectional view showing an initial state of the electromagnetic contactor;

FIG. 4 is a cross-sectional view showing states of rotation of a drive lever and a movement of a movable contact support to an operation position when a movable core of the electromagnetic contactor performs an attraction movement;

FIG. 5 shows a shape of the drive lever constituting the electromagnetic contactor;

FIG. 6 shows an engagement state between the movable contact support and the drive lever constituting the electromagnetic contactor;

FIGS. 7(a), 7(b) are simplified views showing a correct assembly state and an incorrect assembly state of the drive lever;

FIG. 8 shows a state where a cover is attached to a case when the drive lever is correctly assembled; and

FIG. 9 shows a state where the cover cannot be attached to the case in the incorrect assembly of the drive lever.

### BEST MODE FOR CARRYING OUT THE INVENTION

A detailed description is given hereinbelow of the best mode for carrying out the present invention (hereinafter referred to as an embodiment) with reference to the drawings.

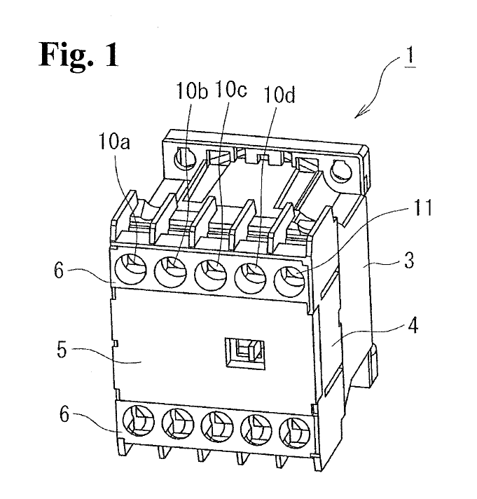

As shown in FIG. 1, an electromagnetic contactor 1 of the present embodiment includes a lowercase 3 and an upper case 4 which are formed of a synthetic resin material having insulation properties.

In the upper case 4, there are disposed terminal portions 10a to 10d each having a contact and coil terminals 11 of an electromagnet. To the upper case 4, an arc extinguishing cover 5 which accommodates a movable contact support 7a in a sealed state is attached.

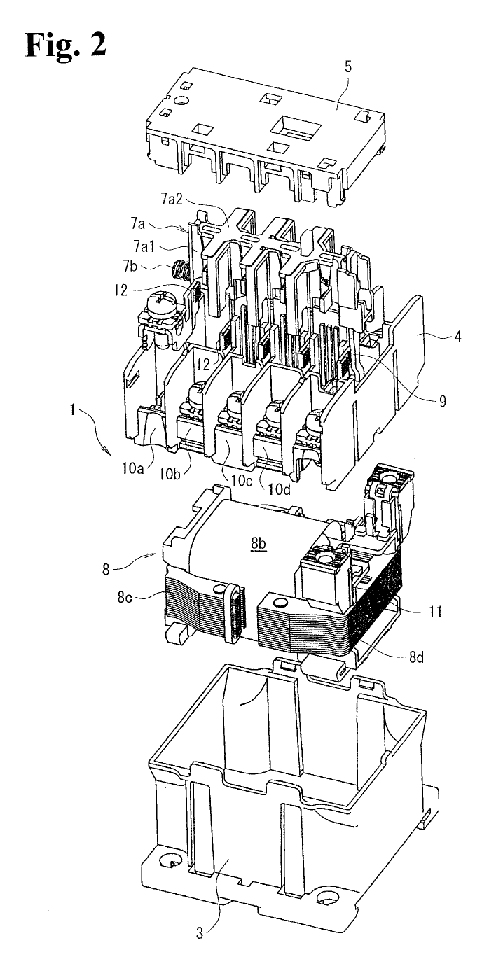

As shown in FIG. 2, in the upper case 4, the movable contact support 7a and a return spring 7b are accommodated.

The movable contact support 7a includes a movable contact support base 7a1 and a movable contact support cover 7a2 which is coupled to the movable contact support base 7a1, and in the movable contact support base 7a1, a plurality of movable contacts (not shown) is disposed in combination with contact springs (not shown). In addition, the terminal portions 10a to 10d each having the contact attached to the upper case 4 are provided with contact pieces 12, and fixed contacts (not shown) provided in the contact pieces 12 face the individual movable contacts.

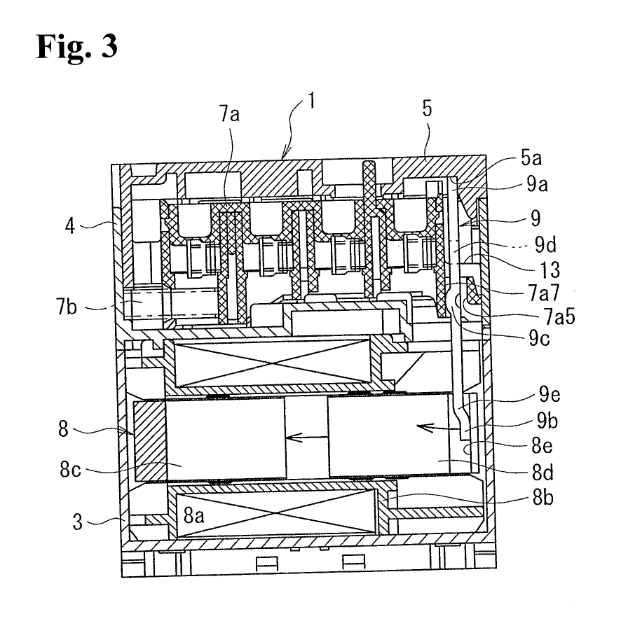

Further, in the lower case 3, an AC-operated electromagnet 8 is accommodated. The electromagnet 8 includes a coil frame 8b having an exciting coil 8a (see FIG. 3) wound therearound, a fixed core 8c which is inserted into a hollow portion of the coil frame 8b and fixed to a side wall of the lower case 3, a movable core 8d which faces the fixed core 8c so as to be movable close to or away from the fixed core 8c and is inserted into the hollow portion of the coil frame 8b, and a pair of coil terminals 11 which are integrally formed with one end side of the coil frame 8b where the movable core 8d is disposed in spaced-apart relation. Note that the pair of coil terminals 11 are disposed side by side with the terminal portions 10a to 10d each having the contact attached in the upper case 4.

As shown in FIG. 3, the movable contact support 7a accommodated in the upper case 4 and the electromagnet 8 accommodated in the lower case 3 are disposed such that a movement direction of an opening and closing operation of the movable contact support 7a and movement directions (an attraction movement direction and a release movement direction) of the movable core 8d are in parallel with each other, and the return spring 7b is disposed such that a urging force acts in a direction in which the movable contact support 7a is returned to an initial position.

In addition, in order to transmit the attraction movement and the release movement of the movable core 8d to the movable contact support 7a, as shown in FIG. 3, a drive lever 9 engaged with one end side of the movable contact support 7a apart from the return spring 7b and the movable core 8d is accommodated to extend between the lower case 3 and the upper case 4.

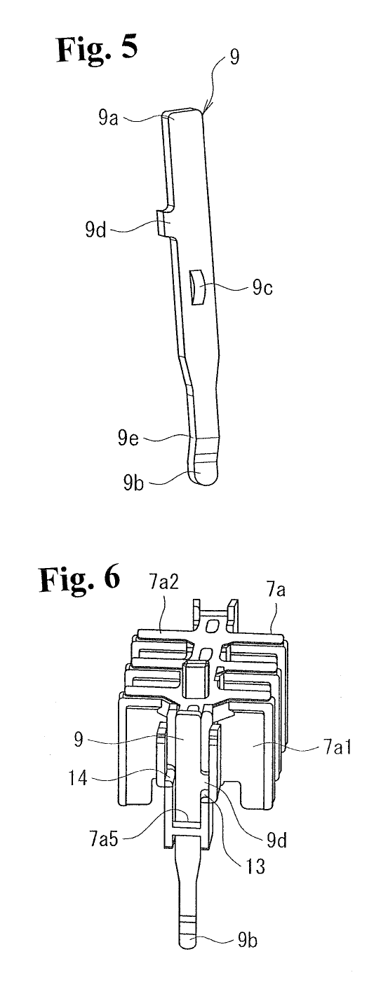

The drive lever 9 is an elongated plate-like member. As shown in FIG. 5, one end thereof in a longitudinal direction serves as a rotation shaft portion 9a, a movable core connection portion 9b is formed on the other end side thereof in the longitudinal direction, a movable contact support connection portion 9c having an expanded shape is provided in a central portion thereof in the longitudinal direction, and one arm portion 9d which protrudes outward from one end surface thereof in a plate width direction is formed at a position closer to the rotation shaft portion 9a than the movable contact support connection portion 9c.

As shown in FIGS. 3 and 6, on one end side of the movable contact support base 7a1 constituting the movable contact support 7a, there is formed a lever passage hole 7a5 through which the drive lever 9 passes from above. As shown on the right side of FIG. 3, the lever passage hole 7a5 is provided with a lever engagement wall 7a7 which can abut on the movable contact support connection portion 9c.

As shown in FIG. 3, the movable core connection portion 9b of the drive lever 9 which has passed through the lever passage hole 7a5 is inserted into a loose-fitting hole 8e formed in the movable core 8d from above and engaged therewith. Herein, there is provided a bend portion 9e between the movable core connection portion 9b and the movable contact support connection portion 9c, and the movable core connection portion 9b inserted into the loose-fitting hole 8e is contacting with an inner surface of the loose-fitting hole 8e which is farthest from the fixed core 8c.

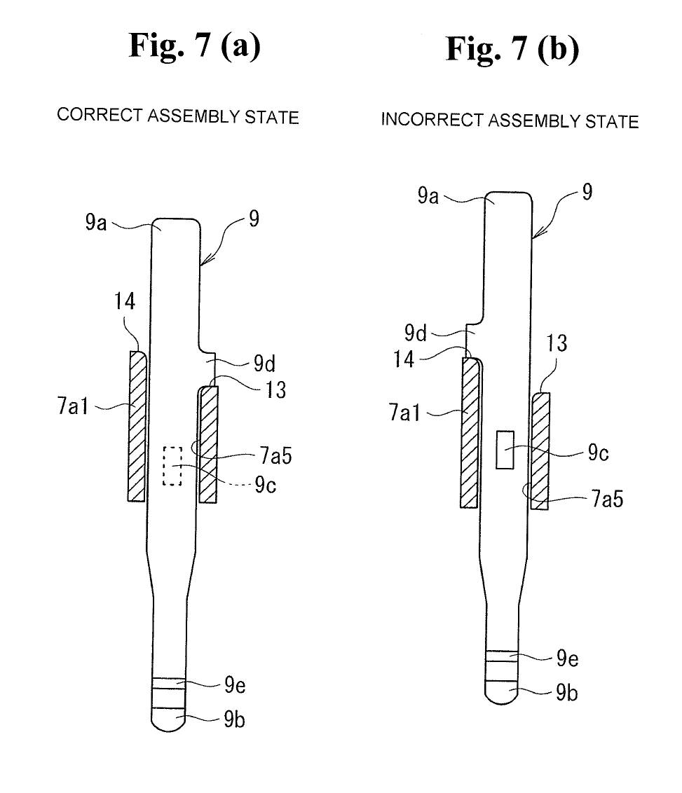

As shown in a correct assembly state of FIG. 7(a), the arm portion 9d which protrudes outward from one end surface of the drive lever 9 in the plate width direction abutably faces an arm portion receiving surface 13 formed on a peripheral edge of an opening portion which is opened on the arc extinguishing cover 5 side of the lever passage hole 7a5.

As shown in FIG. 3, the rotation shaft portion 9a of the drive lever 9 enters into a shaft concave portion 5a provided in a lower surface of the arc extinguishing cover 5, and is rotatably engaged therewith. When the arc extinguishing cover 5 is attached to the upper case 4, the shaft concave portion 5a holds the rotation shaft portion 9a of the drive lever 9, and also presses the arm portion 9d against the arm portion receiving surface 13.

Thus, the drive lever 9, which has the rotation shaft portion 9a rotatably engaged with the shaft concave portion 5a of the arc extinguishing cover 5 and the movable core connection portion 9b engaged with the loose-fitting hole 8e of the movable core 8d (the inner surface of the loose-fitting hole 8e which is farthest from the fixed core 8c), rotates about the rotation shaft portion 9a serving as the rotation shaft with the movement of the movable core 8d, and the rotation of the drive lever 9 is transmitted to the movable contact support 7a via the movable contact support connection portion 9c.

Herein, as shown in FIG. 7(a), on the peripheral edge of the opening portion of the lever passage hole 7a5 facing the other end surface of the drive lever 9 in the plate width direction (the end surface positioned opposite to the end surface formed with the arm portion 9d), there is formed an incorrect assembly preventing surface 14 which is closer to the side of the attachment of the arc extinguishing cover 5 than the above-described arm portion receiving surface 13, and on which the arm portion 9d can abut.

Note that a case of the present invention corresponds to the lower case 3 and the upper case 4, a cover of the present invention corresponds to the arc extinguishing cover 5, one end portion of a drive lever of the present invention corresponds to the movable core connection portion 9b, the other end portion of the drive lever of the present invention corresponds to the rotation shaft portion 9a, and a drive lever incorrect assembly detection portion of the present invention corresponds to the arm portion 9d and the incorrect assembly preventing surface 14.

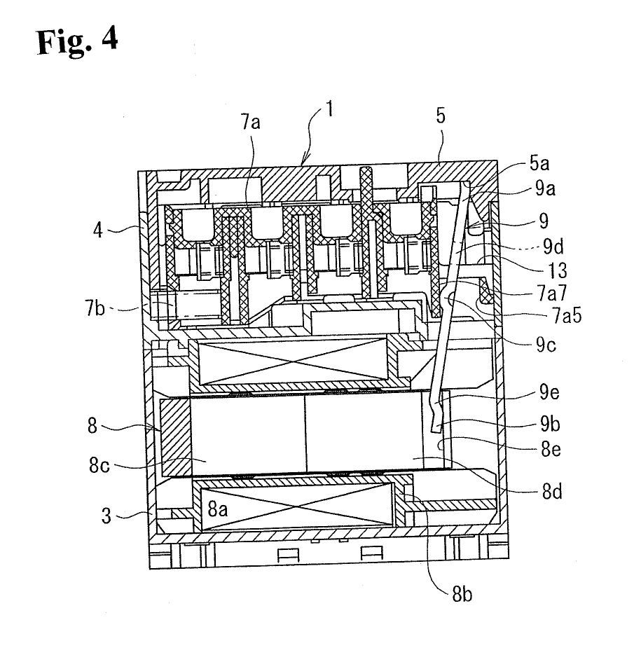

Next, a description is given of the operation of the electromagnetic contactor 1 of the present embodiment with reference to FIGS. 3 and 4.

In the electromagnetic contactor 1 of the present embodiment, when the exciting coil 8a of the electromagnet 8 is in a non-excited state, as shown in FIG. 3, an attraction force does not act between the fixed core 8c and the movable core 8d, and the movable contact support 7a is positioned on the right in FIG. 3 by the urging force of the return spring 7b (hereinafter referred to as an initial position of the movable contact support 7a). At this point, a movable contact 7a3 of a contact a of the movable contact support 7a is apart from the fixed contact, and the movable contact 7a3 of a contact b is in contact with the fixed contact.

Next, when the exciting coil 8a of the electromagnet 8 is brought into the excited state, the attraction force acts between the fixed core 8c and the movable core 8d, and the movable core 8d performs the attraction movement toward the fixed core 8c. As shown in FIG. 4, when the movable core 8d performs the attraction movement toward the left side in the drawing, since the movable core connection portion 9b is in contact with the inner surface of the loose-fitting hole 8e which is farthest from the fixed core 8c, the drive lever 9 rotates clockwise about the rotation shaft portion 9a engaged with the shaft concave portion 5a serving as the rotation shaft, and the movable contact support 7a pressed by the movable contact support connection portion 9c moves in an operation direction against the return spring 7b. When the movable contact support 7a has moved to an operation position, the movable contact 7a3 of the contact a of the movable contact support 7a contacts the fixed contact, and the movable contact 7a3 of the contact b moves away from the fixed contact.

In addition, when the exciting coil 8a of the electromagnet 8 is brought into the non-excited state with the movable contact support 7a at the operation position, the movable contact support 7a on which the urging force of the return spring 7b acts gradually moves to the initial position. Further, an external force is transmitted from the movable contact support 7a moving by the urging force of the return spring 7b via the drive lever 9 and the drive lever 9 rotates counterclockwise, whereby the movable core 8d of the electromagnet 8 performs a release movement in a direction in which the movable core 8d moves away from the fixed core 8c.

Herein, the drive lever 9 of the electromagnetic contactor 1 has directivity at the time of assembly that the assembly is performed such that the movable contact support connection portion 9c abuts on the lever engagement wall 7a7 of the lever passage hole 7a5, and the movable core connection portion 9b contacts the inner surface of the loose-fitting hole 8e formed in the movable core 8d which is farthest from the fixed core 8c.

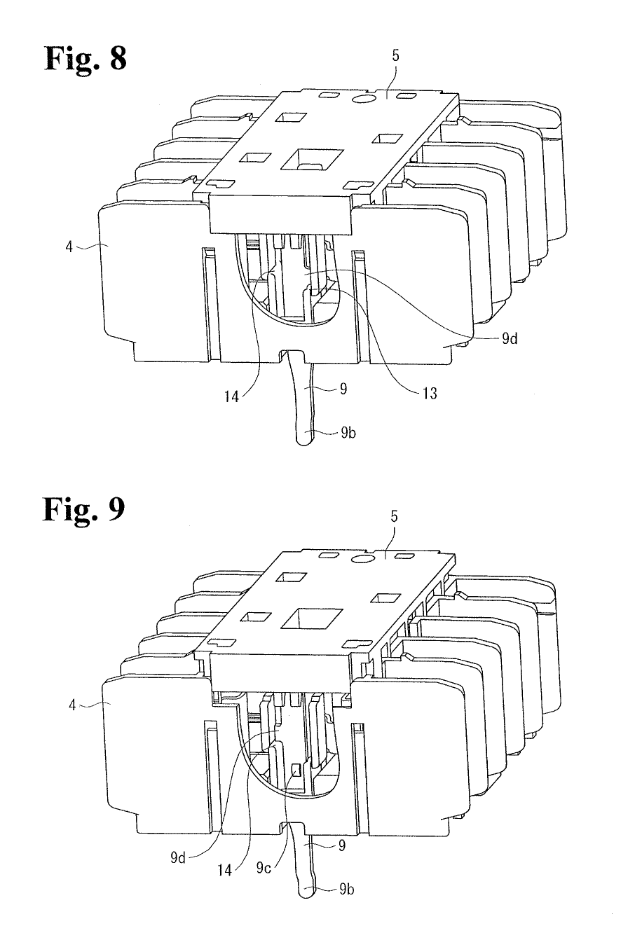

A description is given of cases where the drive lever 9 having directivity at the time of assembly is correctly assembled and incorrectly assembled with reference to FIGS. 7 to 9. Note that each of FIGS. 7(a) and 8 shows the correct assembly of the drive lever 9, while each of FIGS. 7(b) and 9 shows the incorrect assembly of the drive lever 9.

As shown in FIG. 7(a), in the drive lever 9 in the correct assembly, the arm portion 9d protruding outward from one end surface in the plate width direction abutably faces the arm portion receiving surface 13 formed on the peripheral edge of the opening portion opened on the arc extinguishing cover 5 side of the lever passage hole 7a5, and the rotation shaft portion 9a at one end thereof is disposed so as not to protrude into the space in the upper case 4 where the arc extinguishing cover 5 is to be attached. Note that the movable contact support connection portion 9c of the drive lever 9 abuts on the lever engagement wall 7a7 of the lever passage hole 7a5, and the movable core connection portion 9b contacts the inner surface of the loose-fitting hole 8e of the movable core 8d which is farthest from the fixed core 8c.

Subsequently, as shown in FIG. 8, the arc extinguishing cover 5 is attached to the upper case 4, whereby the assembly of the drive lever 9 is completed in a state where the shaft concave portion 5a of the arc extinguishing cover 5 holds the rotation shaft portion 9a, and the arm portion 9d is pressed against the arm portion receiving surface 13.

On the other hand, it is assumed that the incorrect assembly is performed in a state where the orientation of the drive lever 9 is reversed. That is, when the incorrect assembly of the drive lever 9 is performed in a state where the movable contact support connection portion 9c does not abut on the lever engagement wall 7a7 of the lever passage hole 7a5, and the movable core connection portion 9b does not come in contact with the inner surface of the loose-fitting hole 8e of the movable core 8d which is farthest from the fixed core 8c, as shown in FIG. 7(b), the arm portion 9d of the drive lever 9 abuts on the incorrect assembly preventing surface 14 provided on the peripheral edge of the opening portion of the lever passage hole 7a5 which is closer to the side of the attachment of the arc extinguishing cover 5 than the arm portion receiving surface 13.

The arm portion 9d of the drive lever 9 abuts on the incorrect assembly preventing surface 14 closer to the side of the attachment of the arc extinguishing cover 5 than the arm portion receiving surface 13, and the rotation shaft portion 9a of the drive lever 9 is thereby disposed so as to protrude into the space in the upper case 4 where the arc extinguishing cover 5 is to be attached.

Subsequently, as shown in FIG. 9, when trying to attach the arc extinguishing cover 5 to the upper case 4, since the rotation shaft portion 9a of the drive lever 9 protrudes into the space where the arc extinguishing cover 5 is to be attached, it is not possible to attach the arc extinguishing cover 5 to the upper case 4.

Consequently, when the drive lever 9 having directivity at the time of assembly is assembled in the incorrect direction, since it becomes impossible to attach the arc extinguishing cover 5 to the upper case 4, it is possible to easily recognize the incorrect assembly of the drive lever 9.

With this, since it is possible to lessen work for visually ascertaining the orientation of the assembly of the drive lever 9 when the drive lever 9 is assembled, and reduce a time required for the assembly of the electromagnetic contactor 1, it is possible to improve assembly efficiency.

In addition, the structure in which the attachment of the arc extinguishing cover 5 to the upper case 4 is prevented when the incorrect assembly of the drive lever 9 is performed is the structure in which the arm portion 9d formed to protrude from one end surface of the drive lever 9 in the plate width direction abuts on the incorrect assembly preventing surface 14 disposed closer to the side of the attachment of the arc extinguishing cover 5 than the arm portion receiving surface 13 on which the arm portion 9d abuts at the time of the correct assembly to thereby cause the the rotation shaft portion 9a of the drive lever 9 to protrude into the space in the upper cover 4 where the arc extinguishing cover 5 is to be attached, whereby the attachment of the arc extinguishing cover 5 to the upper case 4 is prevented, and, since the attachment of the arc extinguishing cover 5 to the upper case 4 is prevented using the simple structure, it is possible to achieve a reduction in manufacturing cost.

### INDUSTRIAL APPLICABILITY

Thus, the electromagnetic contactor and the assembly method for the same according to the present invention are useful for allowing reliable prevention of the incorrect assembly of the drive lever having directivity at the time of assembly.

### EXPLANATION OF REFERENCE NUMERALS

1 . . . electromagnetic contactor, 3 . . . lower case, 4 . . . upper case, 5 . . . arc extinguishing cover, 5a . . . shaft concave portion, 7a . . . movable contact support, 7a1 . . . movable contact support base, 7a2 . . . movable contact support cover, 7a5 . . . lever passage hole, 7a7 . . . lever engagement wall, 8 . . . electromagnet, 8a . . . exciting coil, 8b . . . coil frame, 8c . . . fixed core, 8d . . . movable core, 8e . . . loose-fitting hole, 9 . . . drive lever, 9a . . . rotation shaft portion, 9b . . . movable core connection portion, 9c . . . movable contact support connection portion, 9d . . . arm portion, 9e . . . bend portion, 10a to 10d . . . terminal portion, 11 . . . coil terminal, 12 . . . contact piece, 13 . . . arm portion receiving surface, 14 . . . incorrect assembly preventing surface

1. An electromagnetic contactor comprising a case accommodating:
an electromagnet having a movable core;
a movable contact support moving in parallel with a moving direction of the movable core; and
a drive lever which has directivity in assembly in the case, one end portion engaged with the movable core, and a central portion in a longitudinal direction engaged with the movable contact support, wherein the drive lever made rotatable about the other end portion thereof serving as a rotation axis transmits a movement of the movable core to the movable contact support by engaging the other end portion of the drive lever to an inner wall of a cover attached to the case covering the movable contact support, and
a drive lever incorrect assembly detection portion is provided in which in a state where the drive lever is assembled in a correct direction, the driver is accommodated to attach the cover on the case, and in a state in which the drive lever is assembled in an incorrect direction, the other end portion of the drive lever protrudes to a position where the cover is attached to the case to prevent the attachment of the cover to the case.

2. An electromagnetic contactor according to claim 1, wherein the drive lever incorrect assembly detection portion comprises:
an arm portion formed in the central portion of the drive lever, and protruding from one end portion in a direction orthogonal to a rotating direction of the drive lever;
an arm portion receiving surface formed on the movable contact support, and on which the arm portion abuts while accommodating the drive lever to attach the cover to the case in the state in which the drive lever is assembled in the correct direction; and
an incorrect assembly preventing surface formed on the movable contact support to be closer to a position where the cover is attached than the arm portion receiving surface, and on which the arm portion abuts to protrude the other end portion of the drive lever to the position where the cover is to be attached to the case in the state in which the drive lever is assembled in the incorrect direction.

3. An assembly method for an electromagnetic contactor according to claim 1, comprising the steps of:
judging, after accommodating the electromagnet, the movable contact support, and the drive lever in the case, whether attaching the cover to the case is possible, or whether the attaching the cover to the case is not possible by protruding the other end portion of the drive lever toward the position where the cover is to be attached to the case; and
determining presence of the incorrect assembly of the drive lever.
